(19) United States
(12) Patent Application Publication
(10) Pub. No.: US 2024/0409205 A1
(43) Pub. Date: Dec. 12, 2024

(54) FLIGHT VEHICLE

(71) Applicant: AERONEXT INC., Tokyo (JP)

(72) Inventor: Yoichi SUZUKI, Tokyo (JP)

(21) Appl. No.: 18/695,734

(22) PCT Filed: Sep. 28, 2021
(86) PCT No.: PCT/JP2021/035663

§ 371 Date: Mar. 26, 2024

(51) Int. Cl. B64C 25/32

(52) U.S. Cl. CPC B64C 25/32

(57) ABSTRACT

The flying vehicle in this invention has landing legs with a grounding part, the grounding part being shaped such that the drag force decreases during traveling rather than during landing. The shape of the grounding part is substantially wing-shaped in the front-rear direction of the airframe, and the angle of attack of the grounding part is reduced when the flying vehicle moves forward than when it lands. The grounding part has an inverted wing shape in the longitudinal direction of the airframe, and the angle of attack of the grounding part is reduced during travel rather than during landing. A plurality of landing legs are provided, and the grounding part of the shape is provided only on the landing leg on the forward side of the airframe. The landing legs are connected to the grounding part and provided with an intermediate member extending at least vertically, and the structure of the grounding part is more fragile than the intermediate member.

### TECHNICAL FIELD

This invention relates to flying vehicles.

### BACKGROUND ART

In recent years, the development and provision of services using flying vehicles such as drones and unmanned aerial vehicles (UAVs; hereinafter collectively referred to as “flying vehicles”) have been progressing. In particular, there is a demand for improved fuel efficiency and reliability in flying vehicles that perform deliveries, surveys, and other tasks.

Flying vehicles are equipped with sensors, circuit boards, etc., and fly by the operation of these devices. Therefore, strong shocks to flying vehicles may be one of the causes that reduce the reliability and service life of flying vehicles.

In Patent Literature 1, a landing leg equipped with an anti-vibration structure is disclosed to reduce the impact when a flying vehicle lands and to prevent the flying vehicle from tipping over or being damaged.

### PRIOR ART LIST

### Patent Literature

[Patent Literature 1] JP2019-214256A

### SUMMARY OF THE INVENTION

### Technical Problem

Patent Literature 1 discloses a landing leg and a flying vehicle equipped with the landing leg that can reduce the shock input from the leg when the flying vehicle lands by equipping the leg of the flying vehicle with rubber feet that reduce shock by elastic deformation and an air spring that reduces shock by compressing air enclosed in an internal space.

This suppresses the shock input to the flying vehicle due to the landing operation, thereby reducing the accumulation of damage to precision equipment such as sensors and circuit boards and improving the reliability of the flying vehicle.

However, the landing legs disclosed in Patent Literature 1 do not take into account the aerodynamic drag created by flying vehicles and their impact on fuel consumption and other factors.

To put the service into practical use, simply preventing the flying vehicle itself from breaking down or extending its service life is not sufficient to reduce the cost of operation. To reduce the cost of operating flying vehicles, it is necessary to improve fuel efficiency during flight.

It is one object of this invention to provide a landing leg of a flying vehicle and a flying vehicle provided with the landing leg, which can suppress the increase of aerodynamic drag of the flying vehicle in a given flight attitude and reduce the impact at the time of landing, while suppressing the increase of weight.

### Technical Solution

According to the invention, a flying vehicle can be provided with a landing leg having a grounding part, wherein the grounding part is shaped to have less drag force when moving forward than when landing.

### Advantageous Effects

According to this invention, it is possible to provide a landing leg that can reduce the effect of wind in a given direction striking the landing leg during the flight of a flying vehicle, improve fuel consumption and stability, and reduce impact during landing.

### BRIEF DESCRIPTION OF THE DRAWINGS

FIG. 1 is a conceptual view of a flying vehicle according to the invention, viewed from the side.

FIG. 2 is a side view of the flying vehicle of FIG. 1 in cruise.

FIG. 3 is a top view of the flying vehicle of FIG. 1.

FIG. 4 is another top view of the flying vehicle of FIG. 1.

FIG. 5 is a functional block diagram of the flying vehicle of FIG. 1.

FIG. 6 is an A-A′ cross-sectional view of the flying vehicle of FIG. 1.

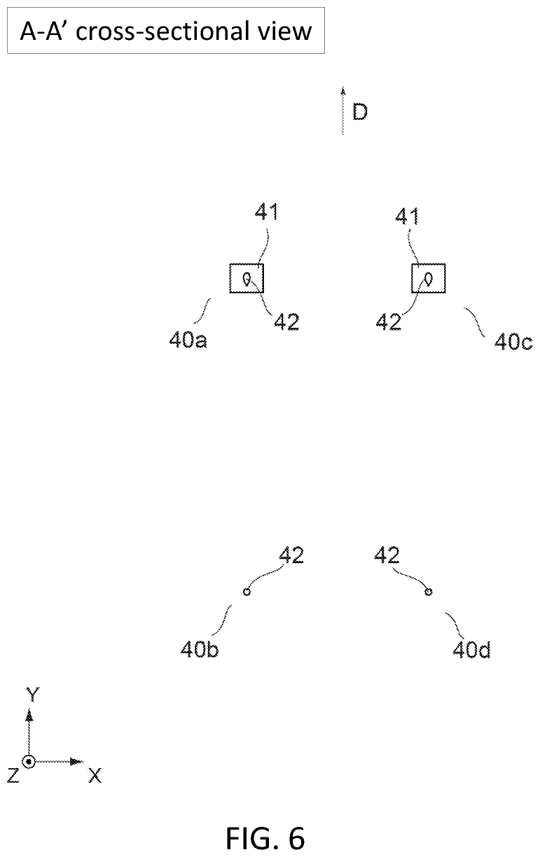

FIG. 7 is a B-B′ cross-sectional view of the flying vehicle of FIG. 1.

FIG. 8 is a B-B′ cross-sectional view of the flying vehicle of FIG. 1 in cruise.

FIG. 9 is an example of a cross-sectional shape of an intermediate member according to the invention.

FIG. 10 is another example of a cross-sectional shape of intermediate members according to the invention.

FIG. 11 is an example of a cross-sectional shape of a landing part according to the invention in the case of a flying vehicle landing.

FIG. 12 is an example of the cross-sectional shape of the landing part of FIG. 11 during cruising of the flying vehicle.

FIG. 13 is another example of the cross-sectional shape of a landing part according to the invention during landing of a flying vehicle.

FIG. 14 is an example of the cross-sectional shape of the landing part of FIG. 13 during cruising of the flying vehicle.

FIG. 15 is another example of a cross-sectional shape of a landing part according to the invention during landing of a flying vehicle.

FIG. 16 is an example of the cross-sectional shape of the landing part of FIG. 15 during cruising of the flying vehicle.

FIG. 17 is another example of a cross-sectional shape of a landing part according to the invention during landing of a flying vehicle.

FIG. 18 is an example of the cross-sectional shape of the landing part of FIG. 17 during cruising of the flying vehicle.

FIG. 19 is a conceptual view of another flying vehicle according to the invention from the side.

FIG. 20 is a conceptual view of a flying vehicle with a radial frame, viewed from the top.

FIG. 21 is a conceptual view of a flying vehicle with a monocoque frame, viewed from the top.

FIG. 22 is a conceptual view from the side of a flying vehicle equipped with a shape that improves flight efficiency during cruise.

FIG. 23 is a side view of the flying vehicle of FIG. 22 in cruising attitude.

### EMBODIMENT OF THE INVENTION

The contents of this embodiment of the invention are listed and described. A flying vehicle according to this embodiment of the invention consists of the following.

### [Item 1]

A flying vehicle, comprising:
a landing leg having a grounding part,
wherein the grounding part is shaped so that the drag force decreases during moving forward rather than during landing.

### [Item 2]

The flying vehicle according to item 1,
wherein the shape of the grounding part is substantially wing-shaped in the front-rear direction of its airframe, and
wherein the grounding portion has a decreasing angle of attack during moving forward rather than during landing.

### [Item 3]

The flying vehicle according to item 1,
wherein the shape of the grounding part is an inverted wing shape in the front-rear direction of the airframe, and
wherein the grounding part has a decreasing angle of attack when moving forward than when landing.

### [Item 4]

The flying vehicle as in any one of items 1 to 3,
wherein the vehicle is equipped with a plurality of landing legs, and
wherein the shaped grounding part is provided only on the landing leg located at the front side of the airframe.

### [Item 5]

The flying vehicle as in any one of items 1 to 4,
wherein the landing leg is connected to the grounding part and provided with an intermediate member extending at least in a vertical direction,
wherein the structure of the grounding part is more fragile than the intermediate member.

### [Item 6]

The flying vehicle according to item 5,
wherein the material of the grounding part is different from the material of the intermediate member.

### [Item 7]

The flying vehicle as in items 5 or 6,
wherein the intermediate member has a cross-sectional shape with less drag than a round or square cross-sectional shape.

### [Item 8]

The flying vehicle according to item 7,
wherein the intermediate member has a cross-sectional shape that is substantially airfoil-shaped in the front-rear direction of the airframe.

### [Item 9]

The flying vehicle according to item 7,
wherein the intermediate member has a cross-sectional shape that is teardrop-shaped in the front-rear direction of the airframe.

### [Item 10]

The flying vehicle according to item 7,
wherein the intermediate member has a cross-sectional shape that is cam-tail shaped in the front-rear direction of the airframe.

### [Item 11]

The flying vehicle as in any one of items 1 to 10,
wherein the grounding part has a hollow structure.

### EMBODIMENT OF THE INVENTION

### Details of Embodiments According to This Invention

The flying vehicle according to this embodiment of the invention is described below with reference to the drawings.

### Details of the First Embodiment

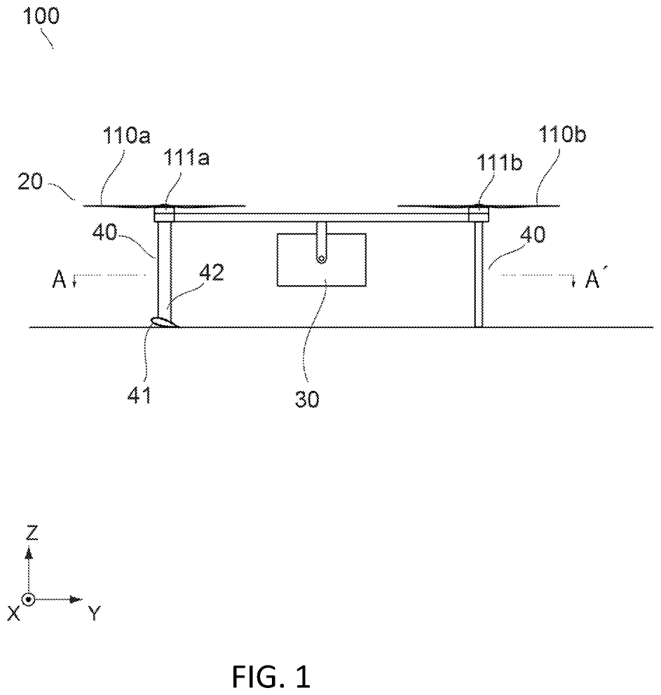

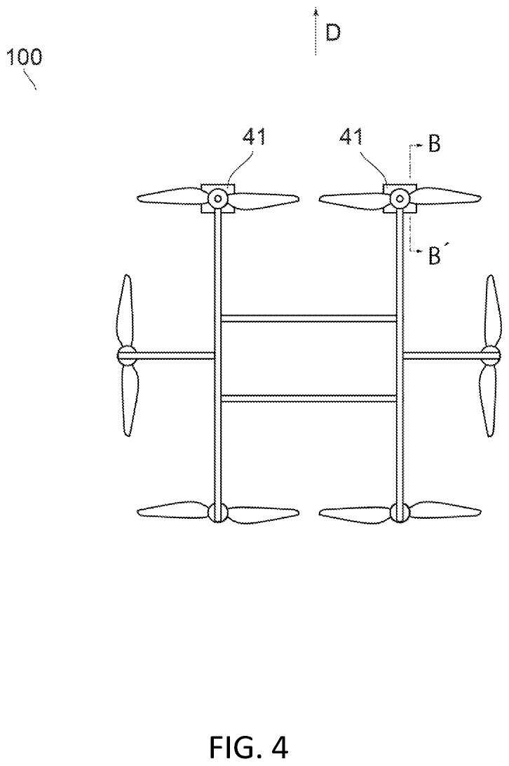

As shown in FIG. 1-FIG. 4, the flying vehicle 100 according to this embodiment of the invention has a flight part 20 that includes a plurality of rotor blade parts comprising at least a propeller 110 and a motor 111 and a frame 21 that connects the rotor blade parts and other elements in order to perform flight. It should also be equipped with energy (e.g., secondary batteries, fuel cells, fossil fuel, etc.) to operate them. The flying vehicle can be a single-rotor aircraft or a fixed-wing aircraft, but it is preferable to use a VTOL aircraft capable of vertical takeoff and landing or a so-called multicopter, a rotorcraft with multiple rotor blades, especially for home delivery applications to individuals. By using an airframe that can take off and land vertically, it is possible to reduce the size of the surrounding equipment, including the takeoff and landing ports.

The flying vehicle 100 shown in the figure is depicted in a simplified form to facilitate the explanation of the invention's structure, and detailed components such as the control part, for example, are not shown in the figure.

The flying vehicle 100 is moving forward in the direction of arrow D (+Y direction) in figures (see below for details).

In the following explanation, the terms may be used according to the following definitions. Forward and backward: +Y and −Y, up and down (or vertical): +Z and −Z, left and right (or horizontal): +X and −X, forward direction (forward): −Y, rearward direction (backward) direction (backward): +Y direction, ascending direction (upward): +Z direction, descending direction (downward): −Z direction.

Propeller 110 rotates by receiving output from motor 111. The rotation of the propeller 110 generates propulsive force to take the flying vehicle 100 off from the starting point, move it, and land it at the destination. The propeller 110 can rotate to the right, stop, and rotate to the left.

The propeller 110 provided by the flying vehicle of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) as the blades are moved through the air. The geometry of the blade/vane can be selected as appropriate to optimize the dynamic aerodynamic characteristics of the vane, such as increasing lift and thrust and reducing drag.

The propeller provided by the flying vehicle of the invention may be, but is not limited to, fixed pitch, variable pitch, and also a mixture of fixed and variable pitch.

The motor 111 produces rotation of the propeller 110, for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flying vehicle 100 determines the number of revolutions of each motor and the angle of flight according to the wind speed and direction by means of the flight controller 1001, ESC 112, and transceiver (propo/radio) 1006. This allows the flying vehicle to perform movements such as ascending and descending, accelerating and decelerating, and changing direction.

The flying vehicle 100 can fly autonomously according to routes and rules set in advance or during the flight, or by using the transceiver (propo/radio) 1006 to control the flying vehicle.

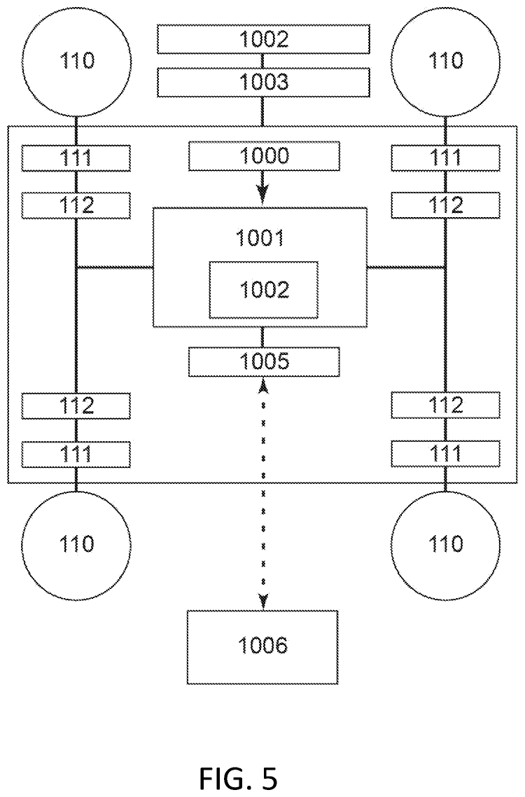

The flying vehicle 100 described above has the functional blocks shown in FIG. 5. The functional blocks in FIG. 5 are a minimum reference configuration. The flight controller 1001 is a so-called processing unit. The processing unit can have one or more processors, such as a programmable processor (e.g., a central processing unit (CPU)). The processing unit has a memory, not shown, which is accessible. The memory stores logic, code, and/or program instructions that can be executed by the processing unit to perform one or more steps. The memory may include, for example, a separable medium such as an SD card or random access memory (RAM) or an external storage device. Data acquired from sensors 1002 may be directly transmitted to and stored in the memory. For example, still and moving image data captured by a camera or other device is recorded in the internal or external memory.

The processing unit includes a control module comprising to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion θx, θy and θz). The control module can control one or more of the states of the loading parts, sensors, etc.

The processing unit can communicate with a transmission/reception unit 1005, which is configured to transmit and/or receive data from one or more external devices (e.g., terminals, display units, or other remote controllers). The transmitter/receiver 1006 can use any suitable means of communication, such as wired or wireless communication. For example, the transmission/reception unit 1005 can use one or more of local area network (LAN), wide area network (WAN), infrared, wireless, WiFi, point-to-point (P2P) network, telecommunication network, cloud communication, etc. The transmission/reception unit 1005 can transmit and/or receive one or more of the following: data acquired by the sensors 1002, processed results generated by the processing unit, predetermined control data, and user commands from a terminal or remote controller.

Sensors 1002 in this embodiment can include inertial sensors (accelerometers, gyroscopes), GPS sensors, proximity sensors (e.g., lidar), or vision/image sensors (e.g., cameras).

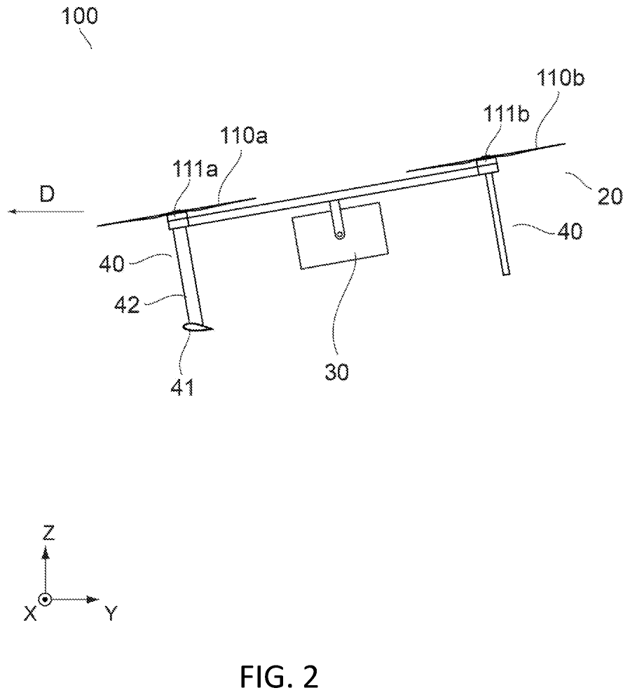

As shown in FIG. 1 and FIG. 2, the flight part 20 provided by the flying vehicle 100 in this embodiment of the invention is facing in the direction of travel when traveling forward, and is tilted forward compared to when hovering. The forward-tilted rotor blades produce upward lift and thrust in the direction of travel, which propels the flying vehicle 100 forward.

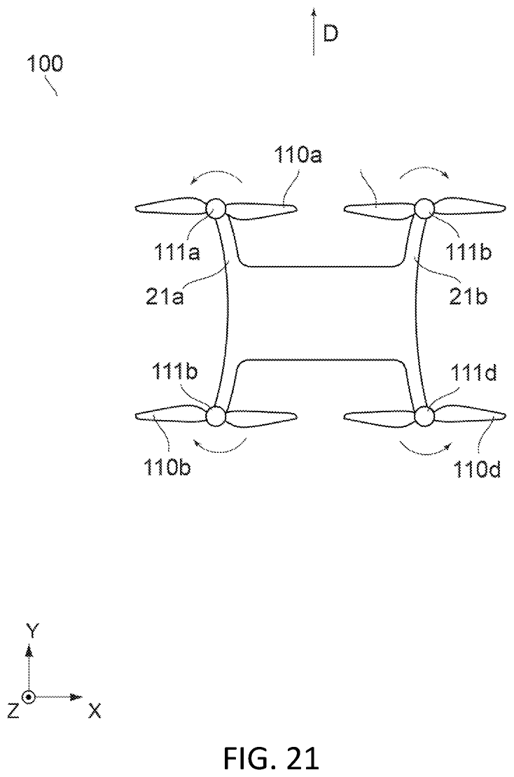

The flying vehicle 100 may be equipped with a loading part 30 that can fly while holding a load, a person, a sensor or a robot for work (hereinafter collectively referred to as “load”) to be transported to the destination. The loading part 30 is fixedly connected to the flight part 20 or independently displaceable via a connection part 31 such as a rotating axis or a gimbal with one or more degrees of freedom, as illustrated in FIG. 21. It may be connected so that the object can be maintained in a predetermined attitude (e.g., horizontal) regardless of the attitude of the flying vehicle 100.

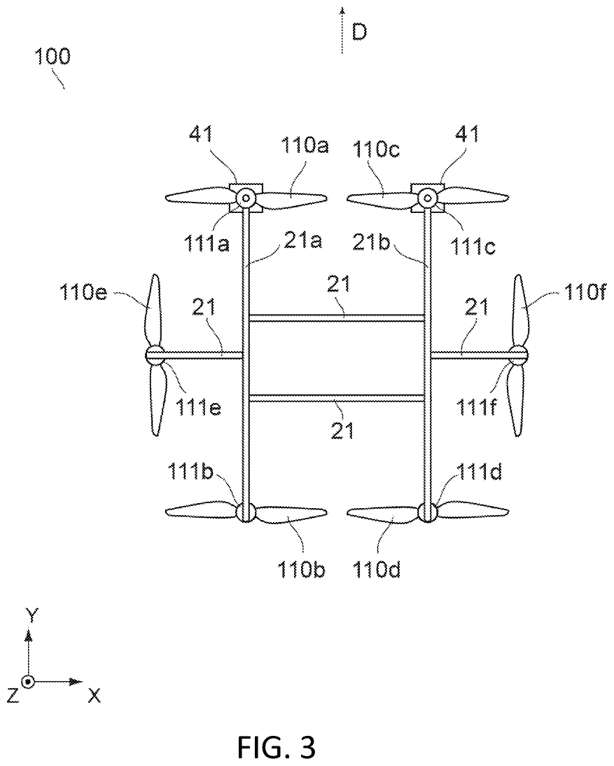

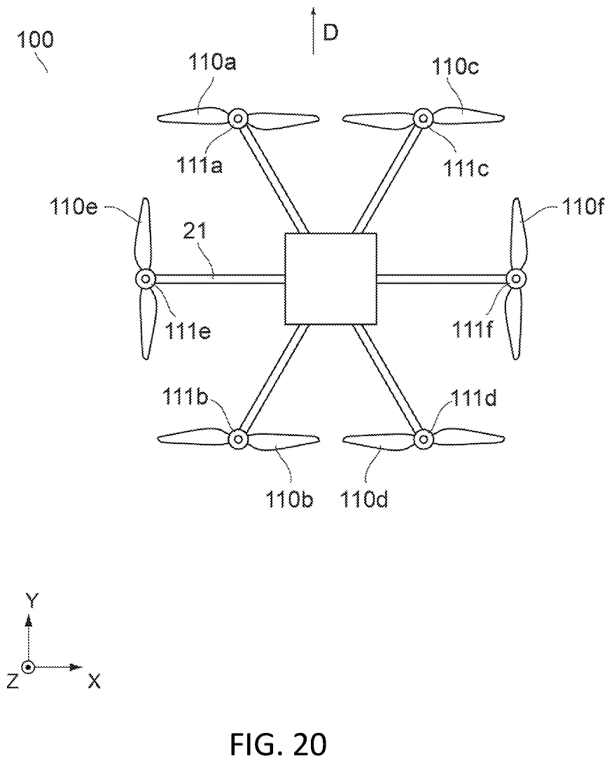

Known flight part shapes of flying vehicles generally include a radial frame as shown in FIG. 20, a rudder-shaped frame as shown in FIG. 3, and a monocoque frame as shown in FIG. 21. Radial and rudder-shaped frames are made of carbon or metal pipes with a circular or square cross-sectional shape of the frame. Radial frames are considered suitable for use in photographic and hobby applications where the direction of flight is not specified, because the drag force of the frame does not change significantly regardless of the direction in which the flying vehicle travels.

However, the frame 21 of the flight part 100 provided by the flying vehicle according to the invention is specialized for a specific direction (e.g., nose direction), which is used for a long time in applications such as transportation of people and objects, inspection, etc., to improve flight efficiency. On top of that, to further improve efficiency in other directions (e.g., left and right directions), it is more desirable to use a rudder-shaped frame or a monocoque frame instead of a radial frame.

The frame and loading parts comprising the flying vehicle 100 are configured with materials that are strong enough to withstand flight and takeoff/landing. For example, resin, FRP, etc. are suitable as materials for constructing the flying vehicle because they are rigid and lightweight. When metals are used, aluminum, magnesium, or other materials with light specific gravity can be used to prevent weight gain while improving strength.

The motor mount, frame, and other parts provided by the 20 flight part may be separate parts and may be composed of connected parts, or they may be molded as a single unit. By integrating the parts, the joints between each part can be made smooth, which is expected to reduce drag and improve fuel efficiency.

The flying vehicle 100 is equipped with landing legs 40 that are in contact with the landing surface.

The landing leg 40 is connected to the flight part or main body part and has an intermediate member 42 extending at least in a vertical direction, and the intermediate member 42 may be connected to a grounding part 41 that is grounded to the landing surface when the flying vehicle lands. The grounding part 41 is provided at one end of the intermediate member 42 and is characterized in that the drag force is reduced when the flying vehicle 100 is in a cruising attitude compared to when the flying vehicle is landing and hovering.

The intermediate member 42 should comprise a material that is strong enough to withstand the weight of the flying vehicle 100 and the impact of takeoff and landing, etc., and is lightweight. Materials used include, but are not limited to, resin, FRP, and metal. These constituent materials may be the same as the frame, etc., or different materials may be used.

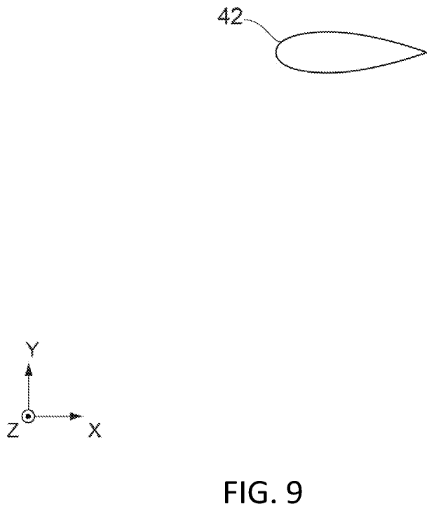

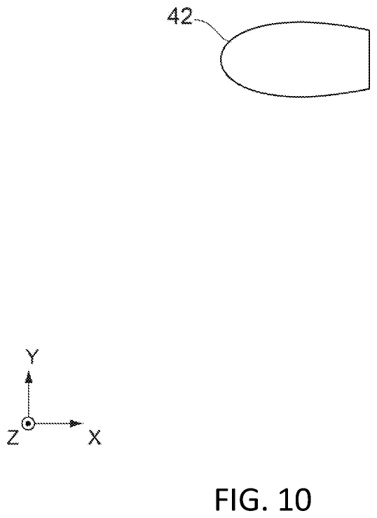

In the intermediate member 42 provided by at least one or more of the landing legs 40, in order to reduce drag increase during flight, it is desirable that the A-A′ cross-sectional shape comprise a substantially airfoil shape, teardrop shape, cam-tail shape, or the like, which has less drag force on the air flowing from forward direction of the flying vehicle, as compared to a round or square shape, as illustrated in FIG. 9 and FIG. 10. By directing the leading edge toward the front of the flying vehicle and the trailing edge toward the rear of the flying vehicle, the generation of drag force when the flying vehicle moves forward can be reduced.

The drag can be efficiently reduced by shaping the intermediate member 42 of the landing leg 40, which is more strongly affected by air striking from the front of the flying vehicle (hereinafter collectively referred to as the wind from the front), to have a less drag force. For example, in a flying vehicle equipped with landing legs on all four sides of the flying vehicle, as shown in FIG. 1-FIG. 3, it is desirable that the intermediate members 42 provided by the two landing legs (40a and 40c) connected to the front of the flying vehicle be shaped to reduce drag.

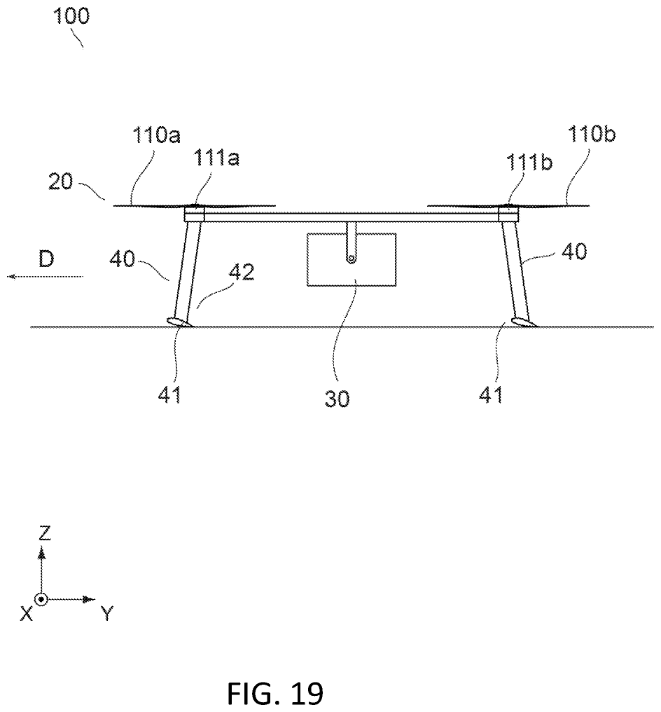

As shown in FIG. 19, it is possible to make the intermediate member 42 of a plurality of landing legs (e.g., all landing legs provided by the flying vehicle 100) shaped to have less drag, thereby reducing its efficacy. However, the two landing legs (40b and 40d) connected to the rear of the flying vehicle may be less effective than the forward landing legs because they may be hidden behind the main body part, loading part, etc. of the flying vehicle during its forward (forward leaning) attitude and may be less affected by air striking from the front. The angle of forward inclination of the flying vehicle, the length of the landing legs, and the balance with the weight should be taken into consideration to determine the intermediate member 42 that uses a shape with less drag force. As shown in FIG. 19, the intermediate member 42 may be configured to extend vertically and horizontally (i.e., leaning and extending with respect to the airframe).

Although the drag reduction effect of the intermediate member 42 is reduced, a round pipe, square pipe, or the like may be used in terms of manufacturing cost, strength, and the like. In addition, by connecting aerodynamic parts to a round or square pipe or other member with a cross-sectional shape that does not take aerodynamic drag into consideration, a cross-sectional shape such as that shown in FIG. 9 or FIG. 10 can be created, which has the effect of reducing drag.

The landing leg connected to the flying vehicle 100 may be provided with a grounding part 41. The grounding part 41 may comprise the same material as the intermediate member 42 or a different material. For example, the grounding part may be composed of lower strength than the intermediate member 42, so that when a predetermined shock or load is applied to the landing leg 40, the grounding part is actively destroyed and has a shock absorbing effect that reduces the impact transmitted to the intermediate member, main body part, and flight part. In the case of shock absorption by breaking the grounding part 41, there are other ways to change the thinness of the part, etc., in addition to the difference in materials, to make the structure easier to break or rupture.

The shape of the grounding part 41 should not increase the drag force when the flying vehicle 100 is flying (traveling). In particular, in the case of a flying vehicle that travels in a specific direction or frequently uses a certain speed range, it can be expected to efficiently improve fuel efficiency by being provided so that the drag force produced by the grounding part 41 is reduced at that attitude (hereinafter collectively referred to as “cruising attitude”), compared to when the vehicle is landing. It is desirable that at least one or more of the landing legs 40 of the flying vehicle 100 be provided with a grounding part 41.

For example, in FIG. 2, the B-B′ cross-sectional shape of the grounding part 41 may be substantially wing-shaped when receiving air striking from the direction of travel as seen from the flying vehicle 100. If the front side of the flying vehicle in the front-back direction is the front edge of the substantially wing-shaped shape and the rear side of the flying vehicle is the rear edge of the substantially wing-shaped shape, the drag force against the wind from the front can be reduced. The wing shape referred to here is an airfoil that has the same characteristics as a symmetrical wing, with the thickness increasing from the leading edge and decreasing from a predetermined position to the trailing edge. However, it is not limited to this, but can also be an substantially airfoil shape where the top surface of the airfoil has a smaller bulge than the bottom surface (so-called inverted airfoil shape) or the bottom surface has a smaller bulge than the top surface (so-called wing shape). This reduces the drag force when the frame is subjected to wind from the direction of the front edge, compared to a frame with a circular cross-sectional shape. The main purpose of the substantially airfoil shape in this invention is to take a shape that efficiently reduces drag, and the shape may be different from that of a wing whose main purpose is to generate lift, for example, it may be an inverted airfoil shape.

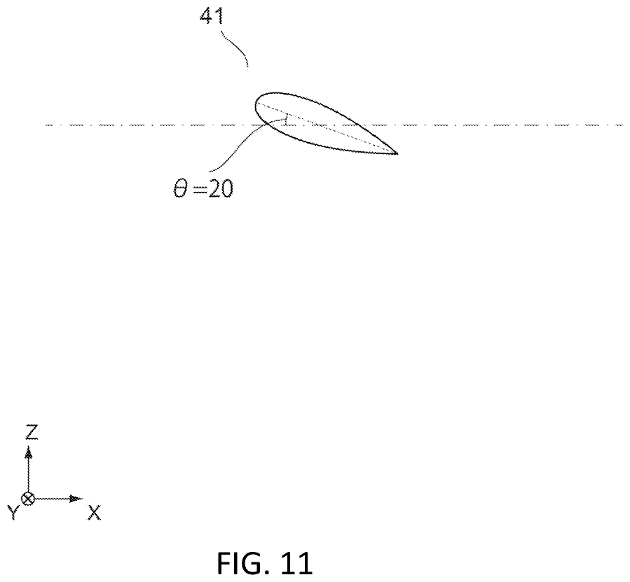

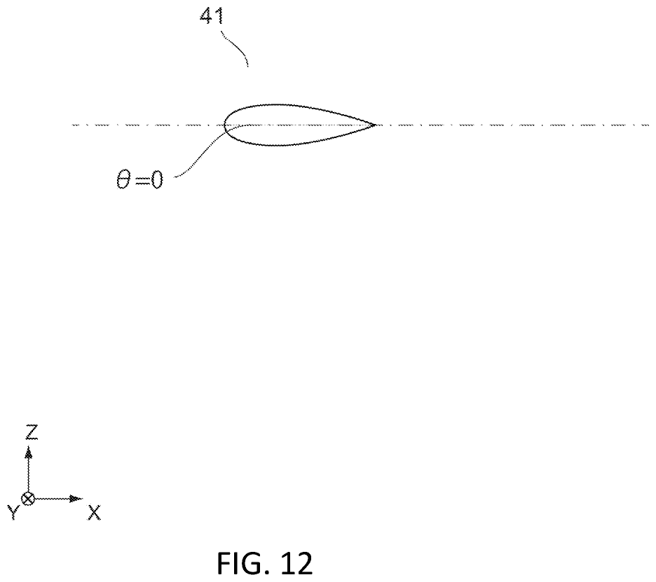

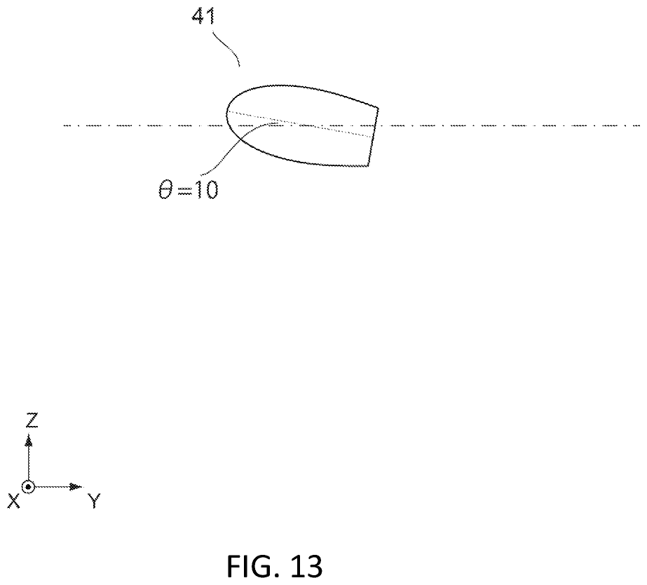

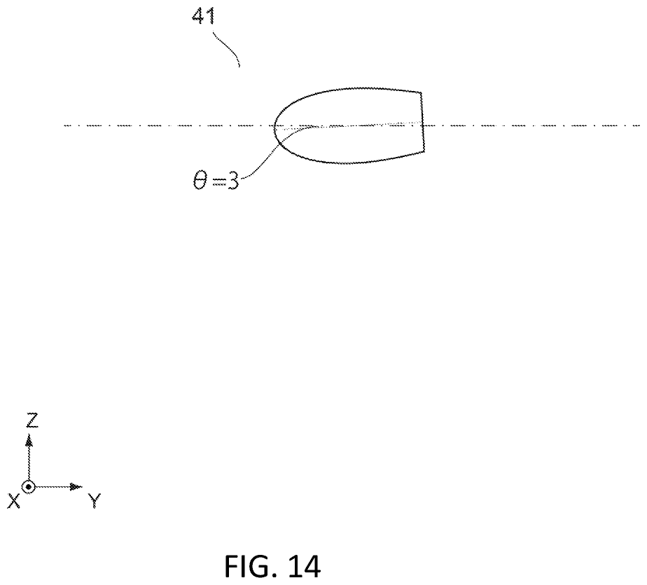

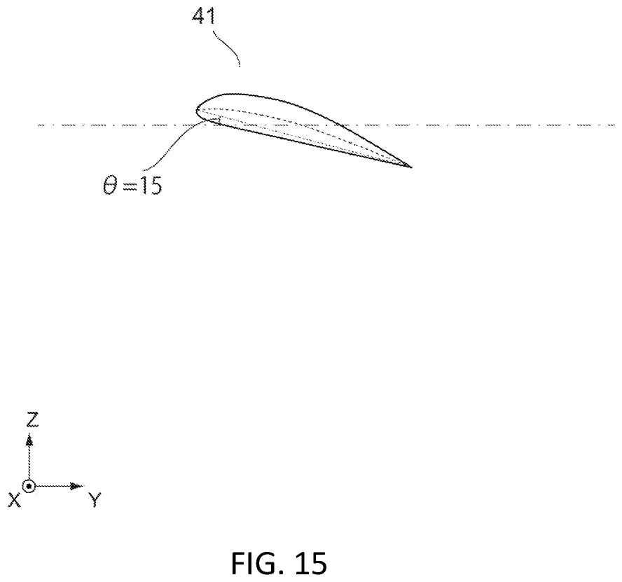

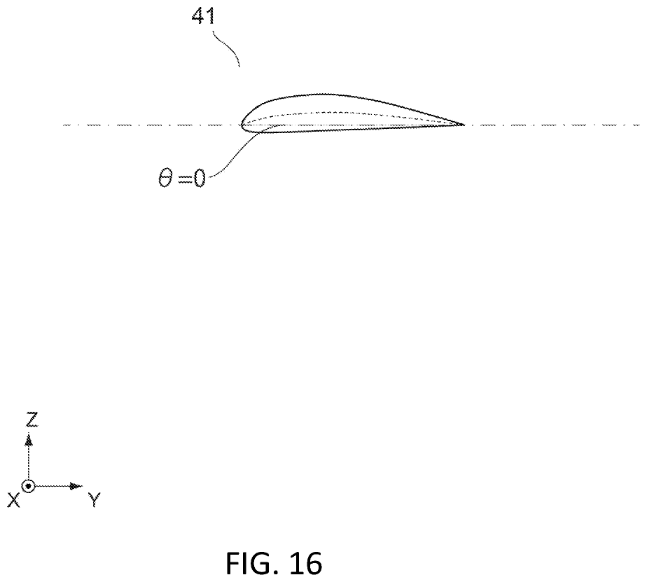

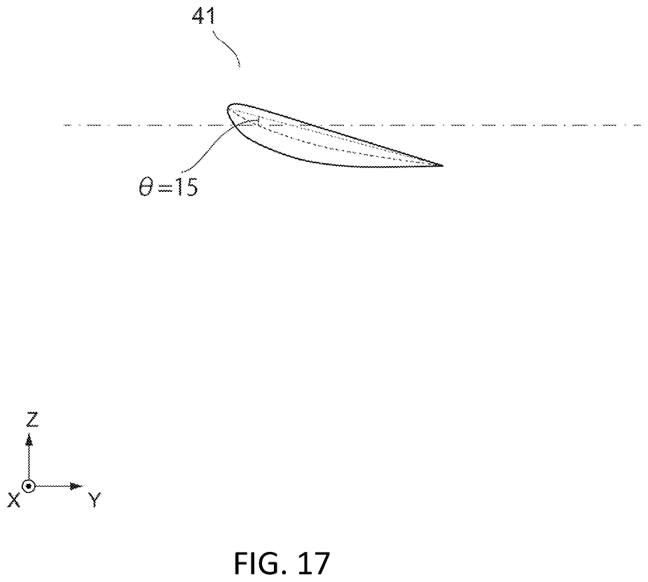

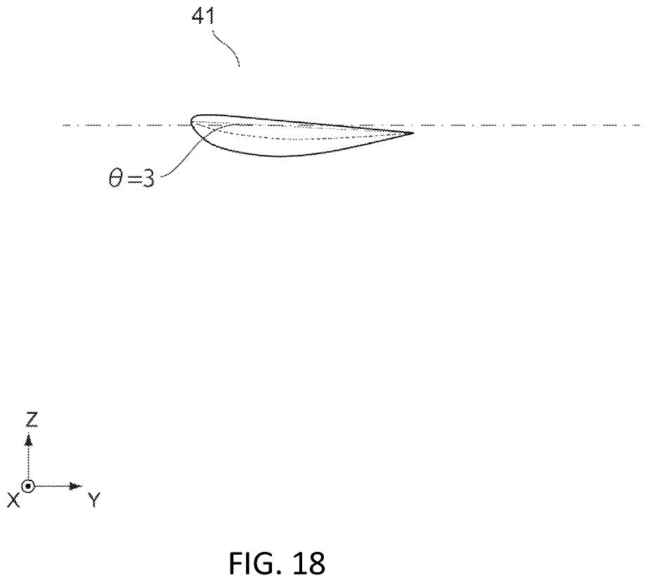

When the grounding part 41 is substantially wing-shaped, the grounding part 41 should be provided so that the drag force is reduced at the cruising attitude compared to the attitude of the flying vehicle 100 when landing or hovering. For example, the angle of attack of the substantially wing-shaped shape can be set so that the angle of attack approaches zero in the cruising attitude compared to the landing or hovering attitude, or the frontal projected area in the frontal view can be set so that the frontal projected area is smaller. For example, as shown in FIGS. 11-18, the drag force on the grounding part 41 in the cruising attitude can be reduced by making the angle of attack (angle θ) closer to 0 degrees in the cruising attitude than in the landing or hovering attitude.

The drag force can be efficiently reduced by shaping the grounding part 41 of the landing leg 40, which is more strongly affected by the wind from the front, so that it has less drag force. For example, in a flying vehicle equipped with landing legs on all four sides of the flying vehicle, as shown in FIG. 1-FIG. 3, the grounding part 41 provided by the two landing legs (40a and 40c) connected to the front of the flying vehicle should be shaped to reduce drag.

As shown in FIG. 19, it is also possible to provide grounding parts 41 on several landing legs (e.g., all 40 landing legs provided by the flying vehicle 100) to reduce drag more. However, the two landing legs (40b and 40d) connected to the rear of the flying vehicle may be less effective than the forward landing legs because they may be hidden behind the main body part, loading part, etc. of the flying vehicle when the flying vehicle is in a forward (forward leaning) attitude and may be less affected by wind from the front. It is desirable to determine landing legs 40 to be provided with grounding parts 41, taking into consideration the angle of forward inclination of the flying vehicle, the length of the landing legs, and the balance with the weight.

The grounding part 41 may be shaped and thick enough to allow the intermediate member 42 to ground the landing surface and maintain the attitude of the flying vehicle in the event that the grounding part is destroyed by impact.

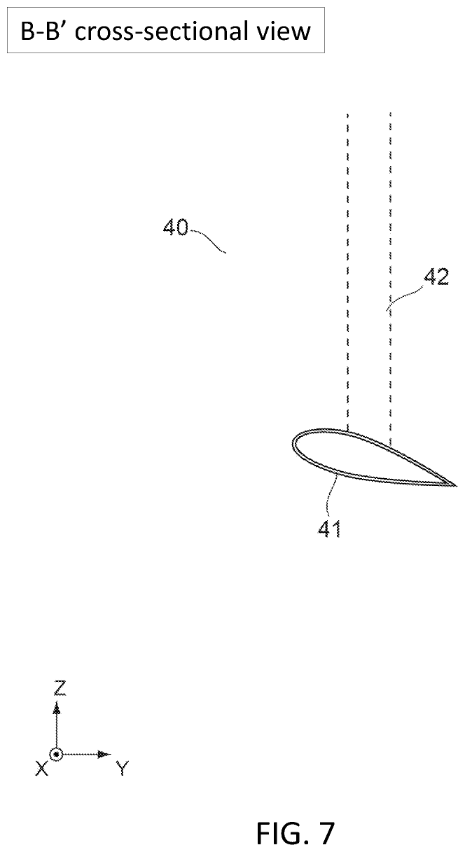

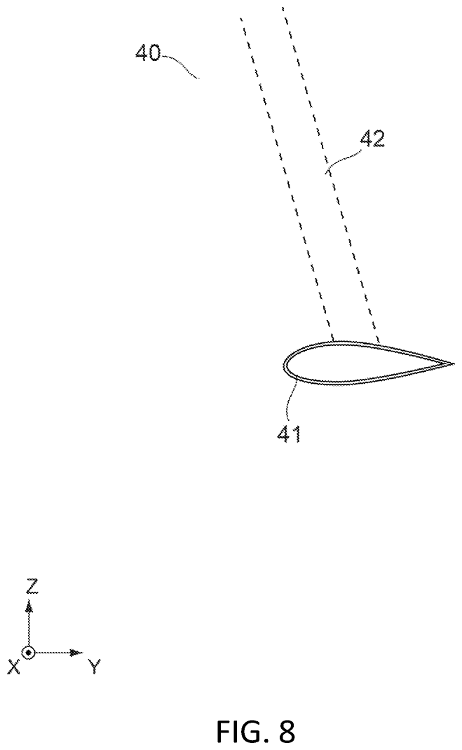

In the top view during landing, the grounding part 41 should have a larger area than the intermediate member 42. This improves landing stability and reduces the possibility of the flying vehicle wobbling or tipping over during takeoff and landing. Shock dispersion can also be expected due to the increased ground contact area. The grounding part 41 can be a cylindrical hollow structure as illustrated in FIG. 7 and FIG. 8. This can provide the effect of a leaf spring, which mitigates impact through elasticity. In addition, shock absorption can be performed with a lighter structure than when a damper or the like is provided.

Since the shape that reduces drag force and streamlining is directional, it is possible to efficiently reduce drag force and streamlining by providing a shape that receives the natural wind from a more appropriate direction.

In other words, in the flying vehicle 100 in which the shape provided by the landing legs 40 is shaped to be effective against wind from the front of the flying vehicle, when the flying vehicle flies to the left or right or retreats, it will not be possible to obtain sufficient drag reduction and wind streamlining effects. Therefore, in this flying vehicle, the more the flying vehicle performs forward motion, the more efficiently it can respond to the wind.

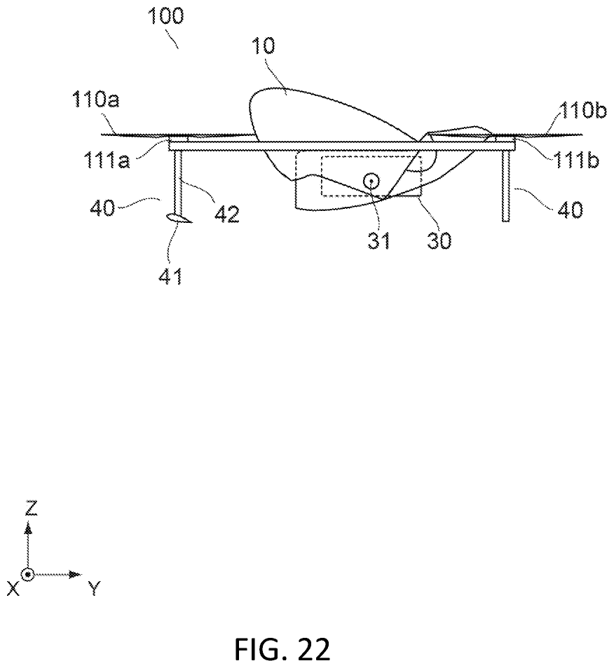

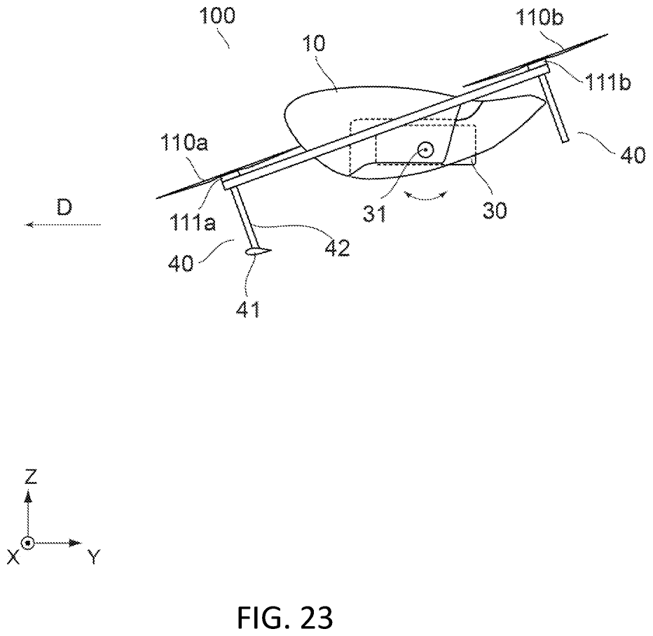

In particular, in a flying vehicle equipped with a main body part 10 having a shape that can improve flight efficiency when the flying vehicle is cruising in the nose direction, as shown in FIGS. 22 and 23, the nose of the flying vehicle can easily face the windward direction, which allows the flying vehicle to face the relative wind and improve its flight efficiency. Further improvement of flight efficiency can be expected by further using the landing legs 40 of the invention on such an aircraft.

It is possible to comprise a flying vehicle in the embodiment by combining several examples. It is desirable to comprise a suitable configuration in accordance with the cost in manufacturing the flying vehicle and the environment and characteristics of the place where the flying vehicle is operated. For example, in addition to using the form of the invention for at least one of the grounding part 41 and the intermediate member 42, there is a method of using the form of the invention for both the grounding part 41 and the intermediate member 42.

The above mentioned embodiments are merely examples to facilitate understanding of the invention and are not intended to be construed as limiting the invention. It goes without saying that the invention may be changed and improved without departing from its purpose, and that the invention includes its equivalents.

### DESCRIPTION OF REFERENCE NUMERALS

20 Flight part
21 Frame
30 Loading part
40a˜40d Landing legs
41 Grounding part
42 Intermediate member
100 Flying vehicle
110a-110f Propellers
111a-111f Motors
112 ESC
1000 Battery
1001 Flight controller
1002 Sensors
1003 Gimbal
1004 Transmission/reception unit
1006 Transceiver (propo/radio)

1. A flying vehicle, comprising:
a landing leg having a grounding part,
wherein the grounding part is shaped so that the drag force decreases during moving forward rather than during landing.

2. The flying vehicle according to claim 1,
wherein the shape of the grounding part is substantially wing-shaped in the front-rear direction of its airframe, and
wherein the grounding part has a decreasing angle of attack during moving forward rather than during landing.

3. The flying vehicle according to claim 1,
wherein the shape of the grounding part is an inverted wing shape in the front-rear direction of the airframe, and
wherein the grounding part has a decreasing angle of attack when moving forward than when landing.

4. The flying vehicle according to claim 1,
wherein the vehicle is equipped with a plurality of the landing legs, and
wherein the shaped grounding part is provided only on the landing leg located at the front side of the airframe.

5. The flying vehicle according to claim 1,
wherein the landing leg is connected to the grounding part and provided with an intermediate member extending at least in a vertical direction,
wherein the structure of the grounding part is more fragile than the intermediate member.

6. The flying vehicle according to claim 5,
wherein the material of the grounding part is different from the material of the intermediate member.

7. The flying vehicle according to claim 5,
wherein the intermediate member has a cross-sectional shape with less drag than a round or square cross-sectional shape.

8. The flying vehicle according to claim 7,
wherein the intermediate member has a cross-sectional shape that is substantially airfoiled-shaped in the front-rear direction of the airframe.

9. The flying vehicle according to claim 7,
wherein the intermediate member has a cross-sectional shape that is teardrop-shaped in the front-rear direction of the airframe.

10. The flying vehicle according to claim 7,
wherein the intermediate member has a cross-sectional shape that is cam-tail shaped in the front-rear direction of the airframe.

11. The flying vehicle according to claim 1,
wherein the grounding part has a hollow structure.
